(19) United States
(12) Patent Application Publication
(10) Pub. No.: US 2016/0220958 A1
(43) Pub. Date: Aug. 4, 2016

(54) ULTRAPURE WATER PRODUCTION APPARATUS

(71) Applicant: KURITA WATER INDUSTRIES LTD., Tokyo (JP)

(72) Inventors: Takeo FUKUI, Tokyo (JP); Hiroshi MORITA, Tokyo (JP); Yoichi TANAKA, Tokyo (JP); Hideaki IINO, Tokyo (JP); Satoshi YAMADA, Tokyo (JP)

(21) Appl. No.: 15/021,178

(22) PCT Filed: Sep. 30, 2014
(86) PCT No.: PCT/JP2014/076109

§ 371 Date: Mar. 10, 2016

(30) Foreign Application Priority Data
Oct. 4, 2013 (JP) 2013-209175
Jan. 28, 2014 (JP) 2014-013478

(51) Int. Cl. B01D 61/58; B01D 61/02; C02F 1/44; B01D 61/14

(52) U.S. Cl. CPC B01D 61/58; B01D 61/145; B01D 61/142; B01D 61/147; B01D 61/025; C02F 1/441; C02F 1/444; B01D 2311/04; B01D 2311/06; B01D 2317/025; C02F 2103/04

(57) ABSTRACT

Provided is an ultrapure water production apparatus capable of producing high-quality ultrapure water from which microparticles have been removed at a high level. An ultrapure water production apparatus comprising a subsystem that produces ultrapure water from primary pure water, the subsystem including a membrane unit disposed at the end of the subsystem, wherein the membrane unit is constituted by a plurality of membrane devices arranged in series, the first of the membrane devices being a UF membrane device, an MF membrane device, or an RO membrane device, the last of the membrane devices being a UF membrane device or an MF membrane that is not modified with an ion-exchange group.

### FIELD OF THE INVENTION

The present invention relates to ultrapure water production apparatuses and particularly relates to an ultrapure water production apparatus including a primary pure water system and a subsystem.

### BACKGROUND OF THE INVENTION

Ultrapure water used for cleaning semiconductors is produced with an ultrapure water production apparatus including a primary pure water system, a subsystem (secondary pure water system), and the like. Optionally, a pretreatment system may be disposed upstream of the primary pure water system.

The pretreatment system, which includes a coagulation unit, a dissolved-air-flotation (sedimentation) unit, a filtration (membrane filtration) unit, and the like, removes suspended substances, colloidal substances, and the like contained in raw water.

The primary pure water system, which includes a reverse osmosis membrane separation device, a deaeration device, an ion-exchange device (mixed-bed type or 4-bed 5-column type), and the like, removes ions, organic components, and the like contained in water to produce primary pure water. The subsystem, which includes a low-pressure ultraviolet oxidation device, an ion-exchange pure water device, an ultrafiltration membrane (UF membrane) device, and the like, treats the primary pure water at a high level to produce ultrapure water. The UF membrane device, which is disposed at the end of the subsystem, removes microparticles generated from an ion-exchange resin and the like.

Recently, the control over the microparticles contained in water has been increasingly tightened due to the development of semiconductor production processes. International Technology Roadmap for Semiconductors requests that the certified value for the number of microparticles having a diameter of more than 11.9 nm being less than 1,000 particle/L (control value: less than 100 particle/L) be achieved by the year 2019.

A UF membrane device is commonly used as a membrane device disposed at the end of the subsystem. In order to remove microparticles through the UF membrane, it is desirable to use a membrane in which pores having a smaller diameter than the microparticles are formed. However, an infinite number of pores are present in the surface of the UF membrane, and the pores have different diameters. Therefore, it is not possible to completely remove microparticles having a diameter of about 10 nm.

The diameter of pores formed in a microfiltration membrane (MF membrane) is on the submicron order and is larger than that of the pores of a UF membrane. Therefore, it is difficult to control the number of microparticles contained in water that permeated through the MF membrane to be 100 particle/L or less (particle diameter >10 nm). The diameter of pores formed in a reverse osmosis membrane (RO membrane) is smaller than that of the pores of a UF membrane. Therefore, in theory, it is considered that microparticles can be removed at a high level through an RO membrane. However, an RO membrane, which has a low degree of cleanliness as a module, may cause microparticles to be generated (e.g., dust particles may be generated from a potting member). Thus, it is not possible to use an RO membrane as a microparticle removal unit disposed at the end of the subsystem.

In order to reduce the number of microparticles contained in ultrapure water, two membrane separation devices may be disposed in series in the subsystem (Patent Literatures 1 to 4). FIGS. 2 and 3 in Patent Literature 1 illustrate a case where a UF membrane device and an ion-exchange-group-modified MF membrane device are disposed in series in this order at the end of an ultrapure water production apparatus. FIG. 4(a) in Patent Literature 2 illustrates a case where a reverse osmosis membrane (RO membrane) device is disposed downstream of a UF membrane device disposed at the end of a secondary pure water system.

Patent Literature 3 describes a technique in which a secondary pure water system includes a UF membrane device and an anion-desorption membrane device having a pore diameter of 500 to 5000 Å. Patent Literature 4 describes a technique in which a prefilter that blocks particles having a diameter of 0.01 mm (10 μm) or more from permeating therethrough is disposed upstream of a UF or MF (microfiltration) membrane device used as a separation membrane module for producing ultrapure water.

When a UF membrane device and an ion-exchange-group-modified MF membrane are arranged in series as in Patent Literature 1, the ion-exchange group may detach from the ion-exchange-group-modified MF membrane to act as a source of the microparticles.

When a UF membrane device and an RO membrane device are arranged in series as in Patent Literature 2, and the quality of ultrapure water may be degraded since microparticles may be generated from the RO membrane.

The anion-desorption membrane described in Patent Literature 3 is specifically a hollow fiber membrane having a pore diameter of 0.2 μm (2000 Å), a porosity of 60%, and a thickness of 0.35 mm (Paragraph 0023). Although silica can be removed at a high level through this anion-desorption membrane, it is not possible to remove microparticles, which are required to be removed in the production of ultrapure water.

The prefilter described in Patent Literature 4 is provided in order to reduce the likelihood of dust particles having a size of 10 μm or more coming into collision with and breaking the UF or MF membrane disposed at the end. Thus, it is not possible to remove particles having a size of less than 10 μm through the prefilter described in Patent Literature 4.

As described above, Patent Literatures 1 to 4 describe techniques in which a plurality of membrane devices are disposed in series as a microparticle removal unit at the end of the subsystem. However, it is not possible to remove microparticles at a sufficient level by using any of these techniques.

### CITATION LIST

### Patent Literature

Patent Literature 1: Japanese Patent Publication 2004-283710 A

Patent Literature 2: Japanese Patent Publication 2003-190951 A

Patent Literature 3: Japanese Patent Publication 10-216721 A

Patent Literature 4: Japanese Patent Publication 4-338221 A

### SUMMARY OF INVENTION

An object of the present invention is to provide an ultrapure water production apparatus capable of producing high-quality ultrapure water from which microparticles have been removed at a high level.

An ultrapure water production apparatus of the present invention includes a subsystem that produces ultrapure water from primary pure water. The subsystem includes a membrane unit disposed at the end of the subsystem. The membrane unit is constituted by a plurality of membrane devices arranged in series. The first of the membrane devices is a UF membrane device, an MF membrane device, or an RO membrane device. The last of the membrane devices is a UF membrane device or an MF membrane that is not modified with an ion-exchange group.

It is preferable in the present invention that the membrane unit is constituted by two UF membrane devices arranged in series. The membrane unit may be constituted by an MF membrane device, an RO membrane device, and a UF membrane device arranged in this order.

It is preferable in the present invention that the apparatus is provided with microparticle measuring means for measuring the number of microparticles contained in treated water for controlling microparticles in the treated water. The apparatus may be provided with microparticle measuring means for measuring the number of microparticles contained in treated water treated with a membrane device immediately before the last of the membrane devices, and/or microparticle measuring means for measuring the number of microparticles contained in water treated with the last of the membrane devices, whereby detecting leakage of microparticles from the membrane device or a decline in a rate of microparticles rejection, so that maintenance including changing a membrane is performed when necessary, resulting that a high grade management of controlling microparticles in ultrapure water produced by the device.

When the ultrapure water production apparatus includes microparticle measuring means capable of measuring the number of microparticles contained in water treated with each of two or more of the membrane devices, the microparticle measuring means may be provided for each of the membrane devices, or may be provided for a plurality of the membrane device, so that the number of microparticles contained in water treated with each of the membrane devices is measured using the microparticle measuring means by switching treated water samples one by one, the treated water samples being fed from the respective membrane devices to the microparticle measuring means in order to measure the number of the microparticles.

When the membrane device includes two or more membrane modules arranged in parallel, it is preferable that microparticles is controlled in each of the membrane modules. Accordingly, it is preferable that a water-sampling pipe including an automatic valve disposed thereon branches from a pipe through which water treated with each of the two or more membrane modules is taken, the water-sampling pipe being used for sampling water in order to measure the number of microparticles and feeding the water to the microparticle measuring means, and that the number of microparticles contained in water treated with each of the membrane modules is measured by switching the automatic valve. It is also preferable that water-sampling pipe including an automatic valve disposed thereon branches through which water treated with each of the two or more membrane modules is merged with one another in order to measure the number of microparticles in the water of the membrane apparatus. A manual valve may be disposed instead of the automatic valve.

### Advantageous Effects of Invention

The ultrapure water production apparatus according to the present invention, which includes a subsystem including a plurality of membrane devices, such as a UF membrane device, disposed in series at the end of the subsystem, is capable of producing high-quality ultrapure water in which the number of microparticles has been markedly reduced. According to the present invention, it is possible to produce high-quality ultrapure water in which the number of microparticles having a diameter of 10 nm or more is less than 100 particle/L.

In the present invention, the last of the plurality of the membrane devices arranged in series is a UF membrane device or an MF membrane device that is not modified with an ion-exchange group. Thus, there is no risk of microparticles being generated from the membrane device as in an RO membrane device. Furthermore, the MF membrane device used in the present invention is not modified with an ion-exchange group. This eliminates the risk of the ion-exchange group detaching from the MF membrane device and acting as a source of the microparticles.

By providing microparticle measuring means for measuring the numbers of microparticles contained in water treated with a membrane device disposed immediately before the last membrane device and/or water treated with the last membrane device and optionally performing maintenance such as replacement of the membrane on the basis of the results of the measurement made by the microparticle measuring means, high-quality ultrapure water in which the number of microparticles having a diameter of 10 nm or more is less than 100 particle/L can be produced with certainty in a consistent manner.

Specifically, as the membrane device is operated, microparticles are accumulated on the surface of the membrane with time and may leak into the treated water. The leakage of microparticles may also occur when the membrane is broken under an external load. This may deteriorate the quality of the ultrapure water that is to be produced. Thus, by providing microparticle measuring means and monitoring the number of microparticles contained in the membrane-treated water by the microparticle measuring means, the leakage of microparticles into the treated water may be prevented.

### BRIEF DESCRIPTION OF DRAWINGS

FIG. 1 is a flow diagram illustrating an ultrapure water production apparatus according to an embodiment.

FIG. 2 is a flow diagram illustrating an ultrapure water production apparatus according to an embodiment.

FIG. 3 is a flow diagram illustrating an ultrapure water production apparatus according to an embodiment.

FIG. 4 is a flow diagram illustrating an ultrapure water production apparatus according to an embodiment which includes first and second membrane devices each including microparticle measuring means.

FIG. 5 is a flow diagram illustrating an ultrapure water production apparatus including microparticle measuring means according to another embodiment.

FIGS. 6a and 6b are graphs illustrating changes with time in the concentrations of microparticles in water treated in UF membrane modules 17A and 17B, respectively, in Example 8.

### DESCRIPTION OF EMBODIMENTS

Embodiments are described below with reference to the attached drawings.

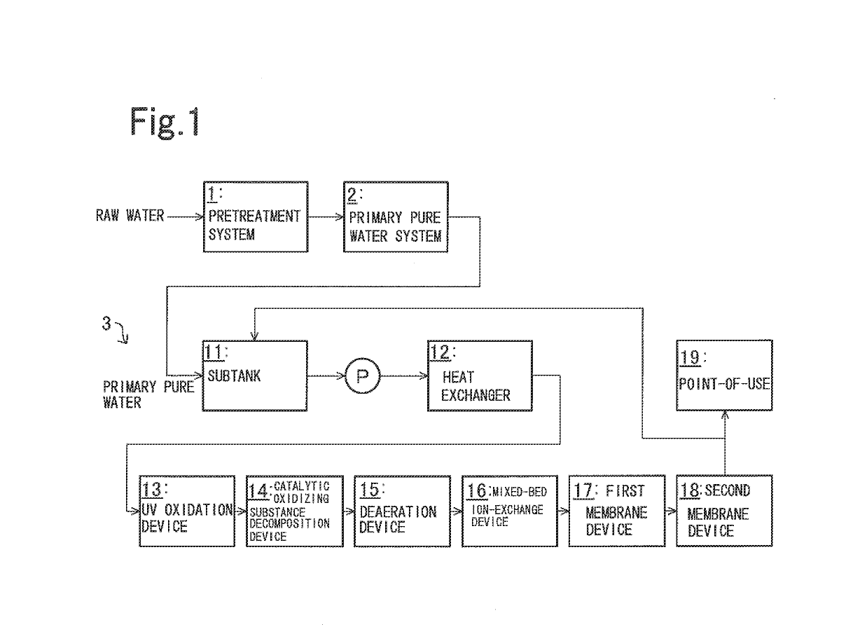

An ultrapure water production apparatus according to the present invention includes a subsystem including two or more membrane devices disposed in series at the end of the subsystem. FIGS. 1 to 3 illustrate examples of the overall flow in the ultrapure water production apparatus including the subsystem.

The ultrapure water production apparatuses illustrated in FIGS. 1 to 3 include a pretreatment system 1, a primary pure water system 2, and a subsystem 3 in common.

The pretreatment system 1, which includes a coagulation unit, a dissolved-air-flotation (sedimentation) unit, a filtration (membrane filtration) unit, and the like, removes suspended substances and colloidal substances contained in raw water. The primary pure water system 2, which includes a reverse osmosis (RO) membrane separation device, a deaeration device, and an ion-exchange device (mixed-bed type, 2-bed 3-column type, or 4-bed 5-column type), removes ions and organic components contained in raw water. The RO membrane separation device removes ionic and colloidal TOC components in addition to salts. The ion-exchange device removes salts. TOC components are also removed by the ion-exchange device by being desorbed on an ion-exchange resin or through ion exchange. The deaeration device (nitrogen deaeration or vacuum deaeration) removes dissolved oxygen.

In the ultrapure water production apparatus illustrated in FIG. 1, primary pure water (generally, pure water having a TOC concentration of 2 ppb or less) produced in the above-described manner is passed through a subtank 11, a pump P, a heat exchanger 12, a UV oxidation device 13, a catalytic oxidizing substance decomposition device 14, a deaeration device 15, a mixed-bed deionization device (ion-exchange device) 16, and first and second membrane devices 17 and 18 used for removing microparticles in order, and the resulting ultrapure water is fed to a point-of-use 19.

The UV oxidation device 13 is generally a UV oxidation device capable of emitting UV radiation having a wavelength of about 185 nm, with which irradiation is performed in the ultrapure water production apparatus. For example, a UV oxidation device including a low-pressure mercury lamp may be used. By using the UV oxidation device 13, TOC contained in the primary pure water is decomposed into organic acids, which are further decomposed into CO₂. Furthermore, H₂O₂ is generated from water due to excess UV radiation emitted from the UV oxidation device 13.

Water treated with the UV oxidation device 13 is subsequently passed into the catalytic oxidizing substance decomposition device 14. As a catalyst for decomposing oxidizing substances which is included in the catalytic oxidizing substance decomposition device 14, noble metal catalysts known as redox catalysts may be used. Examples of the noble metal catalysts include palladium (Pd) compounds such as metal palladiums, palladium oxides, and palladium hydroxides and platinum (Pt). Among the above noble metal catalysts, a platinum (Pt) catalyst, which has high reducing ability, can be suitably used.

The catalytic oxidizing substance decomposition device 14 decomposes and removes H₂O₂ generated in the UV oxidation device 13 and other oxidizing substances by using the catalyst with efficiency. In the decomposition of H₂O₂, water is produced, but oxygen is hardly produced as in the case where an anion-exchange resin or active carbon is used. Therefore, this does not increase the amount of DO.

Water treated with the catalytic oxidizing substance decomposition device 14 is subsequently passed into the deaeration device 15. The deaeration device 15 may be a vacuum deaeration device, a nitrogen deaeration device, or a membrane deaeration device. The deaeration device 15 removes DO and CO₂ contained in the water with efficiency.

Water treated with the deaeration device 15 is subsequently passed into the mixed-bed ion-exchange device 16. The mixed-bed ion-exchange device 16 may be a nonregenerative mixed-bed ion-exchange device filled with an anion-exchange resin and a cation-exchange resin, which are mixed together in accordance with the ionic load. The mixed-bed ion-exchange device 16 removes cations and anions contained in the water to increase the purity of the water. The mixed-bed ion-exchange device 16 may be replaced with a multiple-bed ion-exchange device, an electrically regenerative ion-exchange device, or the like.

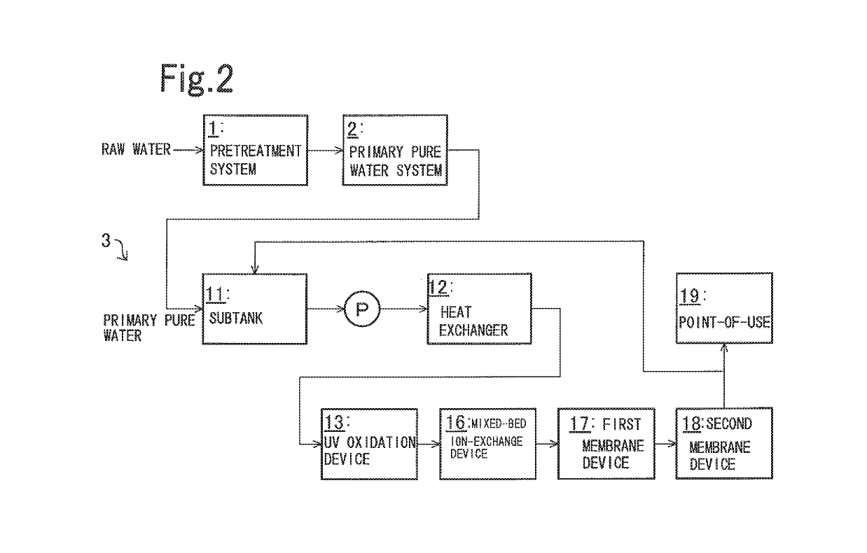

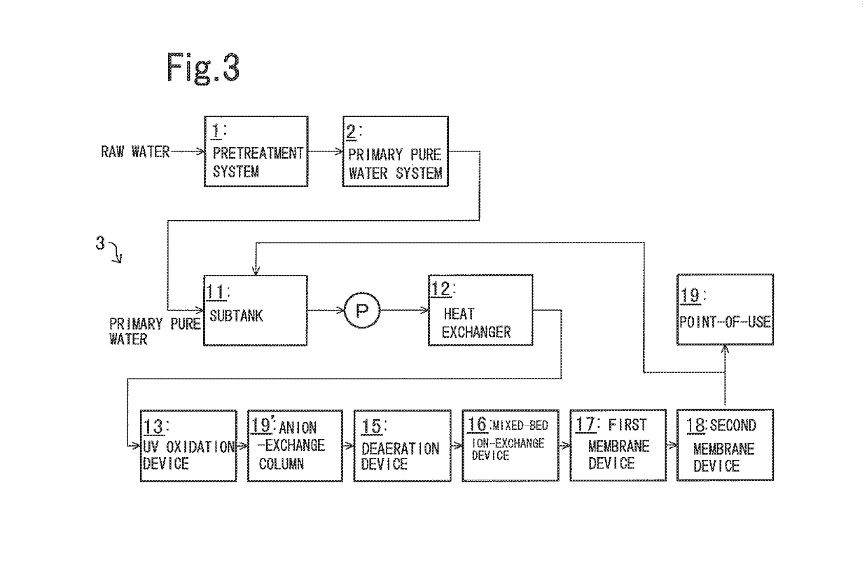

The ultrapure water production apparatus illustrated in FIG. 1 is merely an example of the ultrapure water production apparatus according to the present invention. In the ultrapure water production apparatus according to the present invention, various devices other than those described above may be used in combination. For example, as illustrated in FIG. 2, the UV-irradiation-treated water discharged from the UV oxidation device 13 may be directly introduced into the mixed-bed deionization device 16. As illustrated in FIG. 3, the catalytic oxidizing substance decomposition device 14 may be replaced with an anion-exchange column 19′.

Although illustration is omitted, an RO membrane separation device may be disposed subsequent to the mixed-bed ion-exchange device. The ultrapure water production apparatus according to the present invention may further include a device that performs a thermal decomposition treatment of raw water under an acidic condition of pH 4.5 and in the presence of an oxidizer in order to decompose urea and other TOC components contained in the raw water and subsequently performs a deionization treatment. A plurality of UV oxidation devices, a plurality of mixed-bed ion-exchange devices, a plurality of deaeration devices, and the like may be arranged in series. The pretreatment system 1 and the primary pure water system 2 are not limited to those described above and may include various devices other than those described above.

A membrane included in the first membrane device 17 may be a UF membrane, an MF membrane, or an RO membrane. A membrane included in the second membrane device 18 is a UF membrane or an MF membrane that is not modified with an ion-exchange group. In other words, the following six combinations of the first membrane device 17 and the second membrane device 18 are possible.

(1) UF membrane—UF membrane

(2) UF membrane—MF membrane that is not modified with ion-exchange group

(3) MF membrane—UF membrane

(4) MF membrane—MF membrane that is not modified with ion-exchange group

(5) RO membrane—UF membrane

(6) RO membrane—MF membrane that is not modified with ion-exchange group

Alternatively, three or more membrane devices may be arranged in series. For example, an MF membrane device, an RO membrane device, and a UF membrane device, that is, three membrane devices, may be arranged in series.

In the case where the membrane devices 17 and 18 are an MF membrane device and a UF membrane device, the diameter of pores formed in the membranes is preferably 1 μm or less, is more preferably 0.001 to 1 μm, and is particularly preferably 0.001 to 0.5 μm. The thickness of the membranes is preferably 0.01 to 1 mm. Examples of a material of the membranes include polyolefins, polystyrenes, polysulfones, polyesters, polyamides, cellulosic materials, polyvinylidene fluoride, and polytetrafluoroethylene.

The above-described ultrapure water production apparatus includes a subsystem including a plurality of membrane devices, such as a UF membrane device, disposed in series at the end of the subsystem. This enables high-quality ultrapure water in which the number of microparticles has been markedly reduced to be produced. In addition, the last of the plurality of membrane devices is a UF membrane device or an MF membrane device that is not modified with ion-exchange group. This eliminates the risk of microparticles being generated from the membrane device as in the case where an RO membrane device is used. Furthermore, the MF membrane device used in the present invention is not modified with ion-exchange group. This eliminates the risk of the exchange group detaching from the MF membrane and acting as a source of the microparticles.

In the present invention, the membrane devices preferably employ a cross-flow system and are preferably operated at a recovery ratio of about 95% or less. If the flow rate of brine is further reduced, microparticles may be deposited on the membrane, which reduces the likelihood of the membrane blocking microparticles from permeating therethrough. Alternatively, the number of the membrane devices arranged in series may be changed depending on the quality of feedwater while the membrane devices are operated at a recovery ratio of about 95%.

In the case where two UF membrane devices are used, removal of microparticles is calculated using the following expressions.

C₁=C₀×(1−Re/100)+B

C₂=C₁×(1−Re/100)+B

where,

C₀: Concentration of microparticles contained in water fed into the UF membrane [particle/mL]

C₁: Concentration of microparticles contained in water treated with the first UF membrane [particle/mL]

C₂: Concentration of microparticles contained in water treated with the second UF membrane [particle/mL]

Re: Ratio of rejection of microparticles by the UF membrane [%]

B: Number of microparticles generated from a material of the UF membrane [particle/mL]

The ratio of rejection of microparticles by a microparticle removal membrane is calculated by passing water containing model nanoparticles through the membrane and measuring the number of microparticles contained in water fed to the membrane and the number of microparticles contained in water treated with the membrane.

Although the diameter of pores of an MF membrane is larger than that of pores of a UF membrane, it is expected that an MF membrane has an adsorption effect due to the difference in the qualities of material between a UF membrane and an MF membrane. In the case where an MF membrane and a UF membrane are arranged in series, the UF membrane device is desirably, but not necessarily, disposed at the end, because a UF membrane is capable of blocking microparticles from permeating therethrough at a higher rejection ratio than an MF membrane.

Although an RO membrane has an advantage over a UF membrane in terms of microparticle rejection ratio, microparticles may be generated from the RO membrane or a potting member. Thus, in the case where an RO membrane device is used as a first membrane device, a UF membrane is preferably disposed at the end in order to remove microparticles at a high level.

A booster pump or a valve may be interposed between two membrane devices arranged in series or between each adjacent pair of three or more membrane devices arranged in series. For example, when a plurality of membrane devices are arranged in series, the amount of pressure drop is accordingly increased. Therefore, a pump may be interposed between the membrane devices in consideration of the pressure drop. In such a case, a UF membrane is preferably disposed at the end in order to remove microparticles generated from the pump or the valve. It is desirable that particle-filled equipment such as a mixed-bed ion-exchange device or a catalytic oxidizing substance decomposition device be not interposed between the membrane devices, because such particle-filled equipment may cause a fine powder to be generated due to pulverization of the particles. It is preferable that nothing other than a clean pipe be disposed downstream of the UF membrane disposed at the end.

In the device according to the present invention, an excessively high recovery ratio increases the risk of microparticles being deposited on the membrane. Accordingly, it is preferable to pay attention to the range of recovery ratio. It is preferable to determine the type of the membrane used for removing microparticles and the number of the membrane devices used on the basis of the diameter of microparticles that are to be removed, the flow rate of water-to-be-treated, and the targeted water quality.

As the membrane device is operated, microparticles are likely to accumulate on the surface of the membrane with time and may leak into the treated water. The leakage of the microparticles may also occur when the membrane is broken under an external load. This may deteriorate the quality of the ultrapure water that is to be produced. Accordingly, in the present invention, it is preferable to provide microparticle measuring means and to monitor the number of microparticles contained in the membrane-treated water by the microparticle measuring means in order to prevent the microparticles from leaking into the treated water.

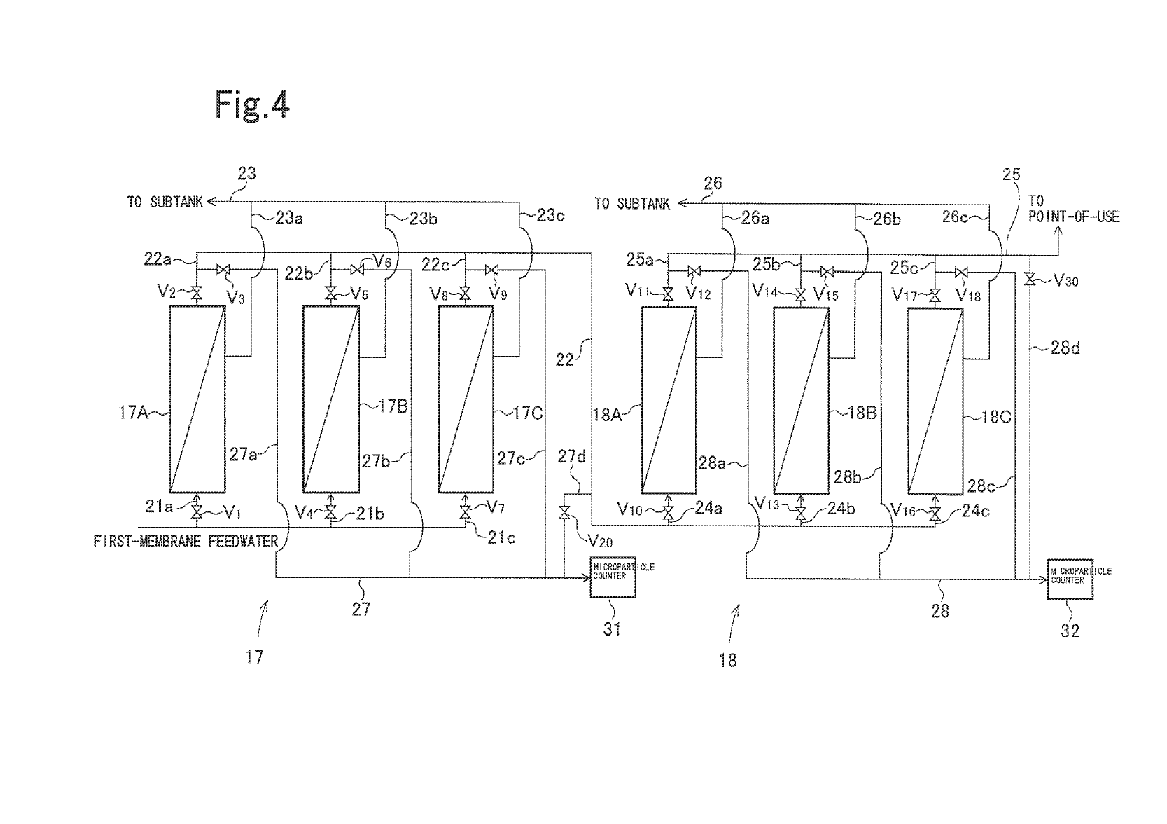

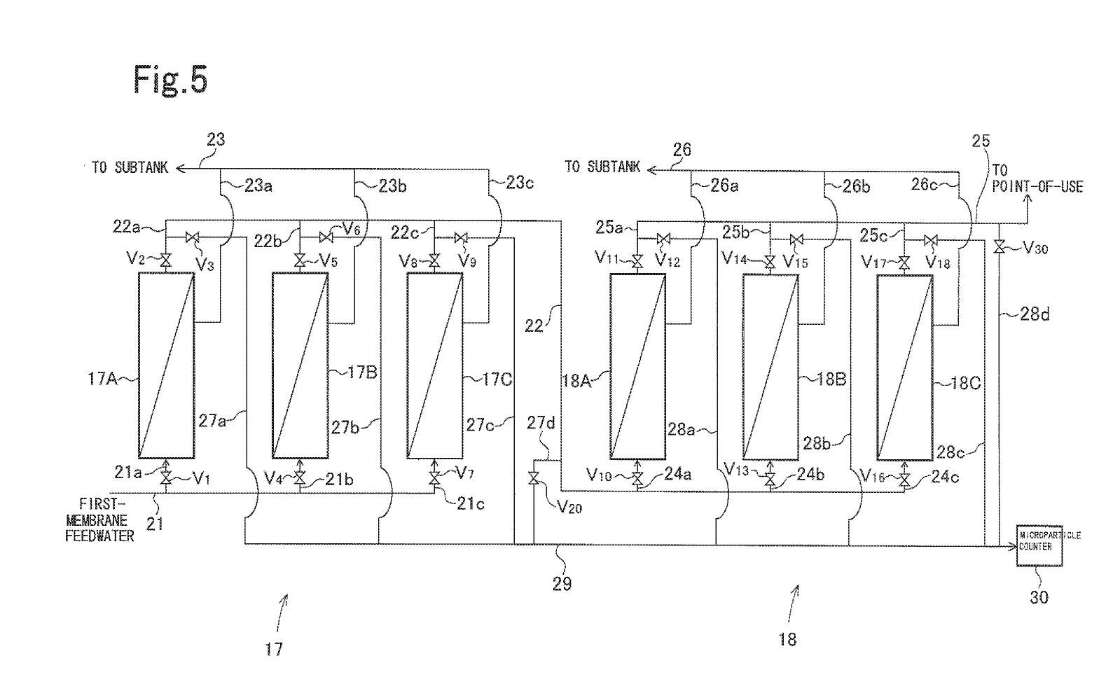

A microparticle control system including the microparticle measuring means is described below with reference to FIGS. 4 and 5. In FIGS. 4 and 5, members having the same function are denoted by the same reference numeral.

The microparticle measuring means is not limited, and any commercially available microparticle measuring means may be used.

FIG. 4 is a flow diagram illustrating a system for controlling microparticles contained in the treated water, which includes a microparticle counter 31 that measures the number of microparticles contained in water treated with the first membrane device 17 and a microparticle counter 32 that measures the number of microparticles contained in water treated with the second membrane device 18.

Hereinafter, treated water fed to the first membrane device 17 (e.g., in the ultrapure water production apparatuses illustrated in FIGS. 1 to 3, water treated with the mixed-bed deionization device 16) is referred to as “first-membrane feedwater”; water fed to the second membrane device 18 (normally, water treated with the first membrane device 17) is referred to as “second-membrane feedwater”; and water treated with the first membrane device 17 and water treated with the second membrane device 18 are referred to as “first-membrane-treated water” and “second-membrane-treated water”, respectively.

In FIG. 4, the first membrane device 17 has three membrane modules 17A to 17C arranged in parallel, and the second membrane device 18 has three membrane modules 18A to 18C arranged in parallel.

The first-membrane feedwater is introduced to the membrane modules 17A to 17C of the first membrane device 17 from a pipe 21 through the respective branch pipes 21a, 21b, and 21c. The first-membrane-treated water is fed to the second membrane device 18 through branch pipes 22a, 22b, and 22c and a junction pipe 22. Membrane-concentrated water is returned to the entry side of the subsystem (in the ultrapure water production apparatuses illustrated in FIGS. 1 to 3, the subtank 11) through branch pipes 23a, 23b, and 23c and a junction pipe 23. Similarly, the second-membrane feedwater (first-membrane-treated water) is introduced to the membrane modules 18A to 18C of the second membrane device 18 from the junction pipe 22 through the respective branch pipes 24a, 24b, and 24c. The second-membrane-treated water, that is, ultrapure water, is fed to a point-of-use through branch pipes 25a, 25b, and 25c and a junction pipe 25. Membrane-concentrated water is returned to the entry side of the subsystem (in the ultrapure water production apparatuses illustrated in FIGS. 1 to 3, the subtank 11) through branch pipes 26a, 26b, and 26c and a junction pipe 26.

Water-sampling branch pipes 27a, 27b, 27c, and 27d are connected to the branch pipes 22a to 22c and a junction pipe 22, respectively, through which water treated with the membrane modules 17A to 17C of the first membrane device 17 is taken from the membrane modules 17A to 17C. Through the water-sampling branch pipes 27a, 27b, 27c, and 27d, part of the treated water is sampled and fed to the microparticle counter 31. The water samples taken through the branch pipes 27a to 27d are fed to the microparticle counter 31 through a junction water-sampling pipe 27, and the number of microparticles contained in the water is measured. Similarly, water-sampling branch pipes 28a, 28b, 28c, and 28d are connected to the branch pipes 25a to 25c and a junction pipe 25, respectively, through which water treated with the membrane modules 18A to 18C of the second membrane device 18 is taken from the membrane modules 18A to 18C. Through the water-sampling branch pipes 28a, 28b, 28c, and 28d, part of the treated water is sampled and fed to the microparticle counter 32. The water samples taken through the branch pipes 28a to 28d are fed to the microparticle counter 32 through a junction water-sampling pipe 28, and the number of microparticles contained in the water is measured.

V₁ to V₁₈, V₂₀, and V₃₀ are automatic valves each disposed on a corresponding one of the above pipes.

The membrane module 17C of the first membrane device 17 and the membrane module 18C of the second membrane device 18 are auxiliary membrane modules; in normal times, the membrane modules 17A and 17B and the membrane modules 18A and 18B are used for removing microparticles.

Specifically, of the automatic valves V₁ to V₁₈, V₂₀, and V₃₀ each disposed on a corresponding one of the pipes, V₇ to V₉ and V₁₆ to V₁₈ are closed, and the automatic valves V₁, V₂, V₄, V₅, V₁₀, V₁₁, V₁₃, and V₁₄ are opened. The automatic valves V₃, V₆, and V₂₀ are opened and closed one by one. Similarly, the automatic valves V₁₂, V₁₅, and V₃₀ are opened and closed one by one.

The first-membrane feedwater is introduced from the pipe 21 to the membrane modules 17A and 17B through the respective branch pipes 21a and 21b and subjected to a membrane treatment. The resulting treated water is fed to the second membrane device 18 through the branch pipes 22a and 22b and the junction pipe 22. The concentrated water produced with the membrane modules 17A and 17B, which contains a high concentration of microparticles, is returned to the subtank disposed on the entry side of the subsystem through the branch pipes 23a and 23b, respectively, and the junction pipe 23.

The first-membrane-treated water is then introduced from the junction pipe 22 to the membrane modules 18A and 18B through the respective branch pipes 24a and 24b and subjected to a membrane treatment. The resulting treated water (ultrapure water) is fed to the point-of-use through the branch pipes 25a and 25b and the junction pipe 25. The concentrated water produced with the membrane modules 18A and 18B, which contains a high concentration of microparticles, is returned to the subtank disposed on the entry side of the subsystem through the branch pipes 26a and 26b, respectively, and the junction pipe 26.

In the embodiment illustrated in FIG. 4, part of water treated with the membrane module 17A, part of water treated with the membrane module 17B, and a mixture thereof, that is, part of the first-membrane-treated water discharged from the first membrane device 17, are fed to the microparticle counter 31 one by one by opening and closing the automatic valve V₃, the automatic valve V₆, and the automatic valve V₂₀ one by one. This enables the number of microparticles contained in water treated with the membrane module 17A, the number of microparticles contained in water treated with the membrane module 17B, which are used for removing microparticles, and the number of microparticles contained in a mixture thereof, that is, the first-membrane-treated water, one by one by using only one microparticle counter 31. Similarly, part of water treated with the membrane module 18A, part of water treated with the membrane module 18B, and a mixture thereof, that is, part of the second-membrane-treated water discharged from the second membrane device 18, are fed to the microparticle counter 32 one by one by opening and closing the automatic valve V₁₂, the automatic valve V₁₅, and the automatic valve V₃₀ one by one. This enables the number of microparticles contained in water treated with the membrane module 18A, the number of microparticles contained in water treated with the membrane module 18B, which are used for removing microparticles, and the number of microparticles contained in a mixture thereof, that is, the second-membrane-treated water, one by one by using only one microparticle counter 32.

By measuring the number of microparticles contained in water treated with each of the membrane modules included in each membrane device, which are used for removing microparticles, and the number of microparticles contained in the entire membrane-treated water, the leakage of microparticles from each membrane module and a reduction in the microparticle rejection ratio of the membrane module can be detected. In addition, the overall performance of the membrane device can be monitored. In the case where the leakage of microparticles from any of the membrane modules or a reduction in the microparticle rejection ratio of any of the membrane modules is detected, feeding of water to the membrane module is stopped, and feeding of water to the auxiliary membrane module is started. Thus, the auxiliary membrane module is used for removing microparticles. Specifically, in the case where the leakage of microparticles into water treated with the membrane module 17A or a reduction in the microparticle rejection ratio of the membrane module 17A is detected, the automatic valves V₁, V₂, and V₃ are closed, the automatic valves V₇ and V₈ are opened, and the automatic valve V₉, the automatic valve V₆, and the automatic valve V₂₀ are opened and closed one by one such that the water treated with the membrane module 17B and the membrane module 17C are used for removing microparticles and such that part of the water treated with the membrane module 17B, part of the water treated with the membrane module 17C, and part of the first-membrane-treated water are sampled one by one and the number of microparticles contained in the water sample is measured using the microparticle counter 31. Meanwhile, maintenance of the membrane module 17A, such as replacement of the membrane, is performed.

The same treatment as in the first membrane device 17 is performed in the second membrane device 18.

The frequency at which the automatic valves are switched for sampling water used for measuring the number of microparticles contained therein is not limited, but preferably such that the number of microparticles contained in water treated with each membrane module and the number of microparticles contained in water treated with the entire membrane device can be measured for 30 to 60 minutes.

As described above, by measuring the number of microparticles contained in water treated with each of the membrane modules arranged in parallel in each membrane device and the number of microparticles contained in water treated with the membrane device and switching flow channels as needed, the leakage of microparticles into the membrane-treated water can be prevented with certainty, which makes it possible to produce high-quality ultrapure water in a consistent manner.

The microparticle control system illustrated in FIG. 5 has the same structure as that illustrated in FIG. 4, except that only one microparticle counter 30 is used instead of the two microparticle counters 31 and 32 illustrated in FIG. 4, and the water samples taken from water-sampling pipes 27a to 27d and water-sampling pipes 28a to 28d are fed to the microparticle counter 30 through a junction water-sampling pipe 29 one by one such that the number of microparticles contained in each treated water sample can be measured using only one microparticle counter 30.

By providing only one microparticle counter for a plurality of membrane devices and measuring the number of microparticles contained in the treated water sample taken from each position one by one by switching the automatic valves, the number of the microparticle counters used can be reduced. Furthermore, an increase in the size of the ultrapure water production apparatus due to the attachment of microparticle counters to the ultrapure water production apparatus may be limited. This reduces the facility cost and the amount of maintenance work.

The number of the membrane modules included in the membrane device is generally, but not limited to, 2 to 20. The number of the auxiliary membrane modules is not limited to one and may be two or more.

The number of microparticles contained in the membrane-treated water may be measured at the last membrane device or a membrane device immediately before the last membrane device. Alternatively, the number of microparticles contained in the treated water may be measured at each of the plurality of membrane devices arranged in series.

In general, the last membrane device is used for finishing the removal of microparticles, and the risk of microparticles leaking into water treated with the last membrane device can be eliminated when a certain degree of microparticle rejection ratio is achieved at a membrane device immediately before the last membrane device. Therefore, it is preferable to dispose the microparticle measuring means, which is used for measuring the number of microparticles contained in the membrane-treated water, at least in the membrane device immediately before the last membrane device. It is preferable to dispose microparticle measuring means in both membrane device immediately before the last membrane device and last membrane device such that the number of microparticles contained in water treated with each of these membrane devices can be measured.

In the above-described embodiment, the concentrated water (brine water) discharged from the first membrane device 17 and the concentrated water discharged from the second membrane device 18 are both returned to the subtank. However, the present invention is not limited to this. Alternatively, the concentrated water may be fed to an additional brine collection tank.

### EXAMPLES

The present invention is described further in detail below with reference to Examples below.

In Examples below, the concentration of microparticles was determined by measuring the number of microparticles having a diameter of 10 nm or more in water by using a centrifugal filtration-SEM microparticle counter.

### Example 1

Ultrapure water was produced using an ultrapure water production apparatus as illustrated in FIG. 1 in which UF membrane devices (external-pressure-type hollow fiber membrane, material: polysulfone, nominal molecular weight cutoff: 6,000 (insulin), rejection ratio Re: 99.90%) were used as a first membrane device 17 and a second membrane device 18 disposed at the end of the subsystem. Table 1 describes the results and the like of the measurement of the concentration of microparticles contained in water fed to each of the membrane devices and the concentration of microparticles contained in water treated with each of the membrane devices.

TABLE 1

| | Abbre- | | |
|---|---|---|---|
| Item | viation | Unit | Value |
| Concentration of microparticles in | C₀ | [Particle/L] | 1,000,000 |
| water fed to first membrane device | | | |
| 17 | | | |
| Rejection ratio | Re | [%] | 99.90 |
| Number of dust particles origi- | B | [Particle/L] | 50 |
| nating from UF membrane | | | |
| Concentration of microparticles | C₁ | [Particle/L] | 1,050 |
| in water treated with first | | | |
| membrane device 17 | | | |
| Concentration of microparticles | C₂ | [Particle/L] | 51 |
| in water treated with second | | | |
| membrane device 18 | | | |

As described in Table 1, while the concentration of microparticles in water treated with the first membrane device 17, was 1,000 particle/L or more, the concentration of microparticles in water treated with the second membrane device 18 was 51 particle/L. This confirms that using two UF membrane devices arranged in series reduces the concentration of microparticles to 100 particle/L or less.

### Examples 2 to 6

Ultrapure water was produced as in Example 1, except that the combination of the first membrane device and the second membrane device was changed as described in Table 2. For each case, the concentration of microparticles was determined by measuring the number of microparticles contained in water. Table 2 describes the results. In addition to the UF membrane devices, the following membrane devices were used.

MF membrane device that is not modified with an ion-exchange group: external-pressure-type hollow fiber membrane, material: surface-modified PTFE, pore diameter: 50 nm

RO membrane device: spiral-wound type, material: polyamide

### Example 7

Ultrapure water was produced as in Example 1, except that three membrane devices arranged in series, that is, an MF membrane device, an RO membrane device, and a UF membrane device, were used. The concentration of microparticles was determined by measuring the number of microparticles contained in water. Table 2 describes the results. The membrane devices used were the same as described above.

TABLE 2

| | | Concentration of microparticles in water | | |
|---|---|---|---|---|
| | | treated with membrane device (particle/L) | | |
| | Combination | First | Second | Third |
| | of membrane | membrane | membrane | membrane |
| No. | devices | device | device | device |
| Example 2 | UF-MF | 1,050 | 100 | |
| Example 3 | MF-UF | 48,050 | 98 | |
| Example 4 | MF-MF | 48,050 | 2,356 | |
| Example 5 | RO-UF | 10,100 | 60 | |
| Example 6 | RO-MF | 10,100 | 535 | |
| Example 7 | MF-RO-UF | 48,050 | 10,005 | 60 |

As described in Table 2, in Examples 2 to 7, high-quality ultrapure water in which the number of microparticles had been markedly reduced was produced by using two or three membrane devices.

### Example 8

Ultrapure water was produced as in Example 1. In Example 8, microparticle counters (“NanoCount25+” produced by Lighthouse) 31 and 32 were disposed in the first membrane device 17 that was a UF membrane device and the second membrane device 18 that was a UF membrane device, respectively, as illustrated in FIG. 4 in order to measure the number of microparticles contained in water treated with each of the first membrane device 17 and the second membrane device 18.

The UF membrane devices used as the first membrane device 17 and the second membrane device 18 included UF membrane modules 17A to 17C and UF membrane modules 18A to 18C, respectively. The UF membrane modules 17C and 18C served as auxiliary membrane modules. In normal times, the UF membrane modules 17A and 17B and the UF membrane modules 18A and 18B were used for performing the treatment.

In the first membrane device 17, water treated with the UF membrane module 17A, water treated with the UF membrane module 17B, and the first-membrane-treated water discharged from the first membrane device 17 were fed to the microparticle counter 31 one by one by switching the automatic valves V₃, V₆, and V₂₀ (at a frequency of once every 30 minutes) in order to measure the number of microparticles contained in the water. Similarly, in the second membrane device 18, water treated with the UF membrane module 18A, water treated with the UF membrane module 18B, and the second-membrane-treated water discharged from the second membrane device 18 were fed to the microparticle counter 32 one by one by switching the automatic valves V₁₂, V₁₅, and V₃₀ (at a frequency of once every 30 minutes) in order to measure the number of microparticles contained in the water.

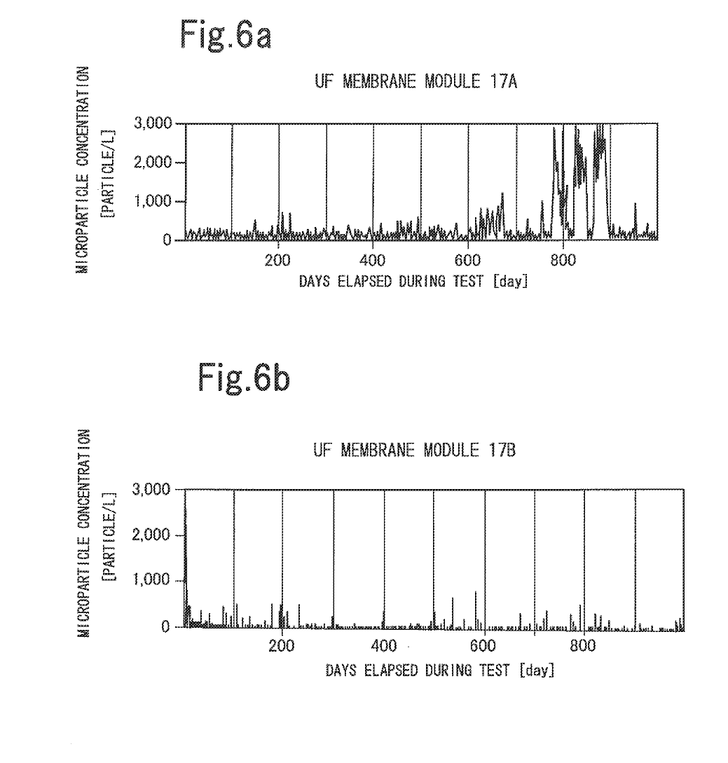

FIGS. 6a and 6b illustrate the changes with time in the concentrations of microparticles which were determined from the results of measurement of the number of microparticles contained in water treated with the UF membrane module 17A and the number of microparticles contained in water treated with the UF membrane module 17B, respectively. This confirms that the durability of the UF membrane module varied over lots even among UF membrane modules included in the same membrane device and that, in the UF membrane module 18A, the leakage of microparticles started earlier than in the UF membrane module 18B.

The treatment was continued by feeding the first-membrane feedwater to the UF membrane module 17B and the auxiliary UF membrane module 17C instead of the UF membrane module 17A and the UF membrane module 17B by switching the automatic valves immediately after the start of the leakage of microparticles from the UF membrane module 18A. As a result, high-quality ultrapure water having a microparticle concentration of 100 particle/L or less was produced with the second membrane device 18 in a consistent manner for a long period of time, as in Example 1.

When the flow channels were not switched as described above, that is, the treatment was continued using the UF membrane module 17A and the UF membrane module 17B, even after the start of the leakage of microparticles from the UF membrane module 18A, microparticles started leaking into water treated with the second membrane device 18 and it became impossible to satisfy the control value for the number of microparticles contained in ultrapure water 600 days after the start of the leakage of microparticles from the UF membrane module 17A.

Although the present invention has been described in detail with reference to a particular embodiment, it is apparent to a person skilled in the art that various modifications can be made therein without departing from the spirit and scope of the present invention.

The present application is based on Japanese Patent Application No. 2013-209175 filed on Oct. 4, 2013, and Japanese Patent Application No. 2014-013478 filed on Jan. 28, 2014, which are incorporated herein by reference in their entirety.

### REFERENCE SIGNS LIST

1 PRETREATMENT SYSTEM
2 PRIMARY PURE WATER SYSTEM
3 SUBSYSTEM
17 FIRST MEMBRANE DEVICE
17A,17B,17C FIRST MEMBRANE MODULE
18 SECOND MEMBRANE DEVICE
18A,18B,18C SECOND MEMBRANE MODULE
30,31,32 MICROPARTICLE COUNTER

1. An ultrapure water production apparatus comprising a subsystem that produces ultrapure water from primary pure water,
the subsystem including a membrane unit disposed at the end of the subsystem,
wherein the membrane unit is constituted by a plurality of membrane devices arranged in series, the first of the membrane devices being a UF membrane device, an MF membrane device, or an RO membrane device, the last of the membrane devices being a UF membrane device or an MF membrane that is not modified with an ion-exchange group.

2. The ultrapure water production apparatus according to claim 1, wherein the membrane unit is constituted by two UF membrane devices arranged in series.

3. The ultrapure water production apparatus according to claim 1, wherein the membrane unit is constituted by an MF membrane device, an RO membrane device, and a UF membrane device arranged in this order.

4. The ultrapure water production apparatus according to claim 1, comprising microparticle measuring means for measuring the number of microparticles contained in water treated with a membrane device immediately before the last of the membrane devices.

5. The ultrapure water production apparatus according to claim 1, comprising microparticle measuring means for measuring the number of microparticles contained in water treated with the last of the membrane devices.

6. The ultrapure water production apparatus according to claim 4, comprising microparticle measuring means capable of measuring the number of microparticles contained in water treated with each of two or more of the membrane devices.

7. The ultrapure water production apparatus according to claim 6, wherein the microparticle measuring means is provided for each of the membrane devices.

8. The ultrapure water production apparatus according to claim 6, wherein the microparticle measuring means is provided for a plurality of the membrane device, and wherein the number of microparticles contained in water treated with each of the membrane devices is measured using the microparticle measuring means by switching treated water samples one by one, the treated water samples being fed from the respective membrane devices to the microparticle measuring means in order to measure the number of the microparticles.

9. The ultrapure water production apparatus according to claim 1, wherein the membrane devices each include two or more membrane modules arranged in parallel,
wherein a water-sampling pipe including an automatic valve disposed thereon branches from a pipe through which water treated with each of the two or more membrane modules is taken, the water-sampling pipe being used for sampling water in order to measure the number of microparticles and feeding the water to the microparticle measuring means, and
wherein the number of microparticles contained in water treated with each of the membrane modules is measured by switching the automatic valve.

10. The ultrapure water production apparatus according to claim 9, wherein another water-sampling pipe including an automatic valve disposed thereon branches from a pipe through which water treated with each of the membrane devices is taken and through which water treated with each of the two or more membrane modules is merged with one another, the other water-sampling pipe being used for sampling water in order to measure the number of microparticles and feeding the water to the microparticle measuring means, and
wherein the number of microparticles contained in water treated with each of the membrane modules and the number of microparticles contained in water treated with each of the membrane devices are measured by switching the automatic valve disposed on the water-sampling pipe branching from the pipe through which water treated with each of the two or more membrane modules is taken and the automatic valve disposed on the other water-sampling pipe branching from the pipe through which water treated with each of the membrane devices is taken.
